(19) United States
(12) Patent Application Publication
(10) Pub. No.: US 2016/0188818 A1
(43) Pub. Date: Jun. 30, 2016

(54) IDENTIFYING CLAIM ANOMALIES FOR ANALYSIS USING DIMENSIONAL ANALYSIS

(71) Applicant: Accenture Global Services Limited, Dublin (IE)

(72) Inventors: Venkatesan Subramanian, Bangalore (IN); Thomas D. Perry, Vienna, VA (US); Meghan Hildebrand Fotopoulos, Philadelphia, PA (US); Gautam Varadarajan, Bangalore (IN); Anoop Kandanga, Thrissur (IN); Lindsey J. Lizardi, State College, PA (US)

(21) Appl. No.: 14/587,539

(22) Filed: Dec. 31, 2014

(51) Int. Cl. G06F 19/00

(52) U.S. Cl. CPC G06F 19/328

(57) ABSTRACT

The present disclosure describes techniques for performing dimensional analysis on a set of healthcare claims to identify subsets of claims that deviate from baseline metrics. One example method includes identifying a plurality of dimensions for analysis within a plurality of healthcare claims; calculating a set of baseline metrics for the plurality of healthcare claims; for each particular dimension of the plurality of dimensions: identifying dimensional subsets including healthcare claims from the plurality of healthcare claims; identifying outlier subsets from the identified dimensional subsets based on differences between the set of subset metrics for each dimensional subset and the set of baseline metrics; and providing, for output, each identified outlier subset and associated differences between the set of subset metrics for each outlier subset and the set of baseline metrics.

### FIELD

This disclosure relates to performing dimensional analysis on a set of healthcare claims to identify subsets of claims that deviate from baseline metrics.

### BACKGROUND

Healthcare providers submit claims for patient services for payment to insurance providers contracted to cover the patients. Such claims may be collected and stored by the insurance providers for later analysis.

Dimensional analysis is a data analysis technique for determining the relationships between different attributes of records within a set of data. A dimension may defined for a data set by grouping records in the data set sharing common values for particular attributes (dimension attributes) into subsets. These subsets may be analyzed individually or compared to one another to identify trends of patterns within the data set correlated to the dimension attributes.

### SUMMARY

The present disclosure describes techniques for performing dimensional analysis on a set of healthcare claims to identify subsets of claims that deviate from baseline metrics. Healthcare claims processing involves receiving claims for payment from healthcare providers and storing records of the claims for later analysis. The stored healthcare claims may then be analyzed to identify anomalous claims, such as, for example, claims with paid amounts less than a correct amount for the claim (underpayments), claims with paid amounts greater than a correct amount for the claim (overpayments), claims that have been manually changed after submission (non-financial edits), and other anomalies. One example methods includes identifying a set of baseline metrics for a set of claims as a whole, and comparing corresponding metrics for different subsets of the claims (dimensional subsets) defined by attribute values (dimension attributes defining a dimension) to the baseline metrics to determine subsets of claims to be further analyzed.

In one aspect, a computer-implemented method includes identifying a plurality of dimensions for analysis within a plurality of healthcare claims, each dimension defined by one or more dimension attributes included in each healthcare claim; calculating a set of baseline metrics for the plurality of healthcare claims representing statistical information about the plurality of healthcare claims; for each particular dimension of the plurality of dimensions: identifying dimensional subsets including healthcare claims from the plurality of healthcare claims, wherein each dimensional subset includes healthcare claims with matching values for each of the one or more dimension attributes defining the particular dimension; calculating a set of subset metrics for each dimensional subset representing the same statistical information for the particular dimension as represented by the set of baseline metrics for the plurality of healthcare claims; identifying outlier subsets from the identified dimensional subsets based on differences between the set of subset metrics for each dimensional subset and the set of baseline metrics; and providing, for output, each identified outlier subset and associated differences between the set of subset metrics for each outlier subset and the set of baseline metrics.

The details of one or more implementations are set forth in the accompanying drawings and the description, below. Other potential features of the disclosure will be apparent from the description and drawings, and from the claims.

### BRIEF DESCRIPTION OF THE DRAWINGS

FIG. 1 is a diagram of an example system for performing dimensional analysis on a data set to identify subsets of records that deviate from baseline metrics.

FIG. 2 is a flow chart of an example method for performing dimensional analysis on a data set to identify subsets of records that deviate from baseline metrics.

FIG. 3 is a flow chart of an example method for generating baseline metrics and subset metrics, and comparing the two to identify outlier subsets.

FIG. 4 is a flow chart of an example method for generating metric queries.

FIG. 5 is a flow chart of an example method for comparing dimensions within a dimension category.

FIG. 6 is a flow chart of another example method for performing dimensional analysis on a data set to identify subsets of records that deviate from baseline metrics.

FIG. 7 is a schematic diagram of an example of a generic computer system.

### DETAILED DESCRIPTION

In the insurance industry, healthcare claims processing involves receiving claims for payment from healthcare providers and storing records of the claims for later analysis. The stored healthcare claims may then be analyzed to identify anomalous claims, such as, for example, claims with paid amounts less than a correct amount for the claim (underpayments), claims with paid amounts greater than a correct amount for the claim (overpayments), claims that have been manually changed after submission (non-financial edits), and other anomalies. These anomalies may indicate inefficiencies and accuracies in the claims process, and thus may be analyzed to determine whether healthcare claims with particular attributes are more likely to exhibit the anomalies. For example, such analysis might reveal that healthcare claims submitted by a certain healthcare provider are overpaid at a rate greater than the rest of the population of healthcare claims, which may lead to further investigation of those particular claims to determine why the overpayments occur. This process is generally an ad hoc process, with analysts attempting to identify attributes of the claims that produce anomalies through trial and error. Such an ad hoc process relies on individual analyst knowledge to identify the claim attributes for analysis, which may be inefficient as different analysts may examine different attributes due to differences in knowledge. Further, the investigation of many different combinations of claim attributes by an analyst may be time-consuming and error-prone.

Accordingly, the present disclosure describes techniques for performing dimensional analysis on a set of healthcare claims to identify subsets of claims that deviate from baseline metrics for the full set of claims. One example method includes identifying dimensions for analysis within the set of healthcare claims. A dimension is defined by one or more dimension attributes included in each healthcare claim. Within the dimension, the set of healthcare claims is divided into dimensional subsets each containing claims including the same values for the dimension attributes. For example, a dimension of the healthcare claims defined by the dimension attributes “city” and “state” may include one dimensional subset including claims with a “city” attribute of “Seattle” and a “state” attribute of “Washington,” and another dimensional subset including claims with a “city” attribute of “Dallas” and a “state” attribute of “Texas.” In some cases, the dimensions for analysis may be configured by an administrator, or may be derived from the set of healthcare claims themselves. In some implementations, all possible dimensions of the set of healthcare claims (e.g., all permutations of dimension attributes) may be identified for analysis.

A set of baseline metrics for the plurality of healthcare claims is calculated representing statistical information about the plurality of healthcare claims. For example, one baseline metric may represent the percentage of overpaid claims in the plurality of healthcare claims. Another baseline metric may represent the average dollar amount by which claims are overpaid in the plurality of healthcare claims.

Each of the identified dimensions for analysis may be analyzed to determine whether metrics for dimensional subsets within the dimension differ from the baseline metrics. Subset metrics are calculated for each dimensional subset representing the same statistical information for the particular dimension as represented by the set of baseline metrics for the plurality of healthcare claims. Outlier subsets from the dimensional subsets may then be identified based on differences between the subset metrics and the set of baseline metrics. For example, if a dimensional subset has an overpayment percentage that differs from the baseline overpayment percentage by greater than a threshold amount (e.g., 10%), the dimensional subset may be identified as an outlier. The identified outlier subsets and the associated differences may be provided as output. In some cases, the outlier subsets may be prioritized according to the degree of difference between the subset metrics and the associated baseline metric such that outlier subsets showing a greater difference may be given a higher priority. In some cases, the outlier subsets may be assigned to analysts for further analysis.

In some cases, additional dimensions including different permutations of the dimension attributes for one of the dimensions for analysis may also be analyzed. In some implementations, these dimensions may be compared to one another to determine which combination of dimension attributes yields the biggest difference from the baseline metrics. For example, if a first dimension includes an outlier subset with a 10% difference from a baseline metric and a second dimension includes an outlier subset with a 20% difference from the baseline metric, the second dimension may be identified as having a larger difference and thus prioritized higher than the first dimension.

The techniques described herein may provide several advantages. By automating the identification of dimensions contributing to anomalies within the healthcare claims, information about such dimensions may be saved and used to analyze additional sets of healthcare claims using the same dimensions, as opposed to the ad hoc process described above that is dependent on the particular knowledge of the individual analyst. Further, by automatically identifying and prioritizing outlier subsets for additional analysis, the time-consuming and error-prone manual process is eliminated, which may lead to greater efficiency and cost savings. In addition, by prioritizing the analysis of the identified outlier subsets, the techniques may ensure that analysts spend time analyzing dimensional subsets with the greatest likelihood of contributing to anomalies in the healthcare claims, which may lead to further cost savings and greater efficiency. Code and output structures used by the dimensional analysis may also be generated dynamically, thereby decreasing the engineering effort required to perform such analysis.

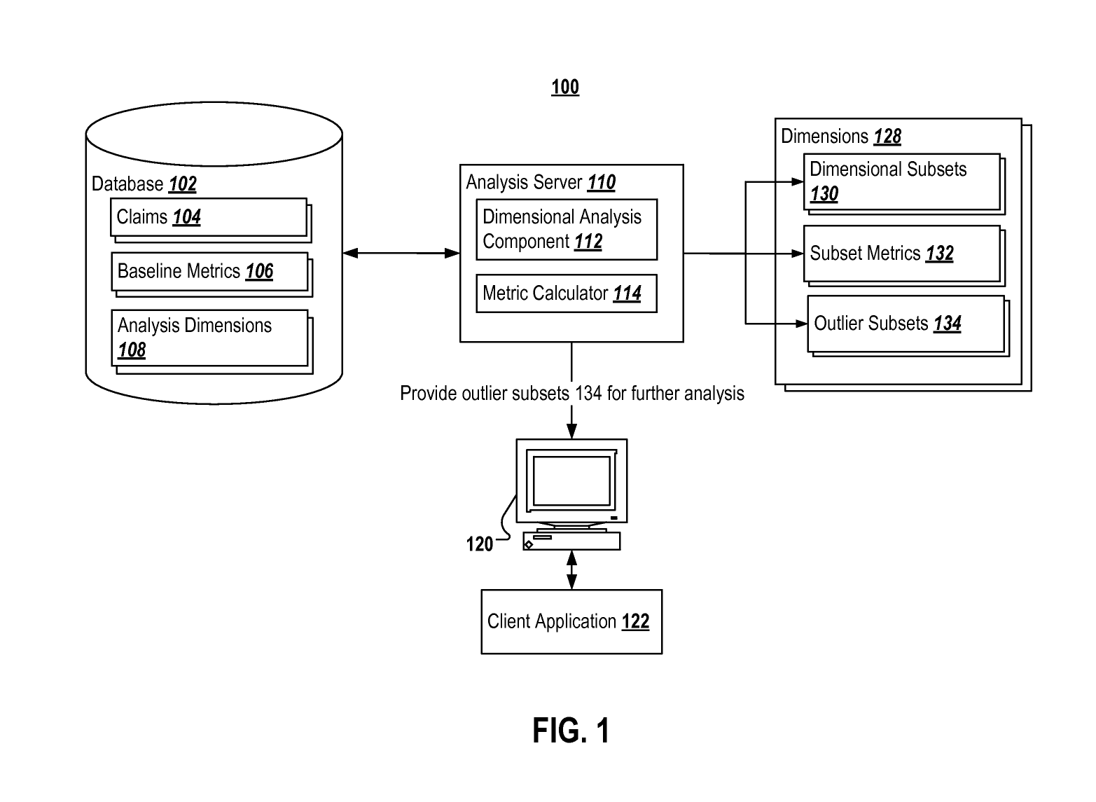

FIG. 1 is a diagram of an example system 100 for performing dimensional analysis on a data set to identify subsets of records that deviate from baseline metrics. System 100 includes an analysis server 110 directed to a database 102 and a client 120. In operation, the analysis server 110 analyzes a set of claims 104 in the database 102 to produce a set of baseline metrics 106 representing statistics about the set of claims 104 as a whole. For example, the baseline metrics 106 may include a percentage of the set of client 104 that were underpaid or overpaid, an average monetary amount of each overpayment or underpayment, or other metrics. The analysis server 110 queries the claims 104 using the analysis dimensions 108 to produce a plurality of dimensions 128. Each dimension 128 includes a plurality of dimensional subsets 130 each representing a group of claims from the claims 104 having the same values for the attributes included in the analysis dimension 108. The analysis server 110 calculates a set of subset metrics 132 for each of the dimensional subsets 130. The set of subset metrics 132 correspond to the baseline metrics 106 in that they represent the same statistics about a particular dimensional subset 130 as the baseline metrics 106 represent about the claims 104 as a whole. The analysis server 110 compares the subset metrics 132 for each of the dimensional subsets 130 to the baseline metrics 106 to identify outlier subsets 134. The outlier subsets 134 are dimensional subsets with associated subset metrics 132 that differ from the baseline metrics 106. In some cases, a dimensional subset 130 may be identified as an outlier subset 134 if one or more of its associated subset metrics 132 differ from the corresponding baseline metrics 106 by greater than a threshold amount. The analysis server 110 provides the outlier subsets 134 as output to the client 120. In some cases, the outlier subsets 134 are provided to the client 120 as a prioritized list. For example, the outlier subsets 134 may be prioritized such that an outlier subset 134 having a larger difference between its subset metrics 132 and the baseline metrics 106 will be given a higher priority than an outlier subset 134 having a smaller difference between its subset metrics 132 and the baseline metrics 106. In some implementations, this priority may be used to determine an order in which the outlier subsets 134 are analyzed by an analyst.

The system 100 includes the database 102. In some cases, the database may be organized and implemented according to one or more database architectures, including, but not limited to, relational, object-oriented, columnar, or other architectures. The database 102 may include a set of data organized and managed by a database management system (not shown). The set of data may be organized into tables, objects, views, or other organizational structures. In some implementations, the database 102 may include executable instructions, such as, for example, scripts, triggers, stored procedures, or other instructions. In some cases, all or a portion of the components of the analysis server 110 (discussed below) may be integrated into the database 102 and implemented using the included executable instructions. In some implementations, the analysis server 110 may use executable instructions included in the database 102 to perform portions of the analysis described below. The database 102 may include a single computing device, or multiple computing devices organized into a distributed system. The distributed system may be implemented such that each of the computing devices stores a portion of the data stored by the database 102, and such that the computing devices communicate with one another via a communications network. In some implementations, the database 102 may implement a query language for data retrieval and manipulation, such as, for example, Structured Query Language (SQL).

Database 102 includes one or more claims 104. Each of the claims 104 includes information about a particular healthcare claim, such as, for example, a healthcare provider that submitted the claim, an amount paid to the healthcare provider in response to the claim, or other information about the particular healthcare claim. In some cases, each of the claims 104 is a row within a table included in the database 102. Each of the claims 104 may also be multiple rows within multiple tables included in the database 102. The table or tables storing the claims 104 may include columns defining attributes of the claims 104. Each of the claims 104 may include values associated with these columns describing attributes of the particular claim.

The system 100 also includes the analysis server 110. In some implementations, the analysis server 110 may be a computing device or set of computing devices connected to the database 102 and operable to query and analyze the claims 104 stored in the database 102. The analysis server 110 may also be a software program or set of software programs executed by a computing device to perform the described analysis. In some cases, the analysis server 110 may perform the analysis operations described below in response to a received request, such as a request received from the client 120. The various components of the analysis server 110 described below may be software modules within the analysis server 110, software programs executed by the analysis server 110, external computing devices communicating with the analysis server 110 via a network, or other types of components.

The analysis server 110 includes a dimensional analysis component 112. In operation, the dimensional analysis components 112 may interact with the database 102 to perform dimensional analysis on the claims 104 to identify the outlier subsets 134 for further analysis. The dimensional analysis component 112 may analyze the claims 104 to produce a set of baseline metrics 106 associated with the claims 104. In some cases, the baseline metrics 106 may be stored in the database 102 by the dimensional analysis component 112. The dimensional analysis component 112 may also store the produced baseline metrics 106 in another location, such as in a memory of the analysis server 110. Dimensional analysis component 112 may utilize the metric calculator 114 to produce the baseline metrics 106. In some implementations, the metric calculator 114 may include instructions for calculating different types of metrics in a particular set of claims. For example, the metric Letter 114 may include instructions for calculating percentage of claims that were overpaid in the particular set of claims. In some cases, the metric calculator 114 may be implemented as a set of executable instructions within the database 102 that are called by the analysis server 110 to calculate the baseline metrics 106 and the subset metrics 132 (described below).

The dimensional analysis component 112 may query the analysis dimensions 108 to determine dimensions within the claims 104 to create and analyze. In some implementations, each of the analysis dimensions 108 may include a set of dimension attributes defining a dimension to be analyzed. For example, an analysis dimension 108 may include the dimension attributes city and state, which may cause a dimensional analysis component 112 to produce and analyze a dimension of the claims 104 grouped into subsets including claims sharing a common value for the attributes city and state.

The dimensional analysis component 112 may produce one or more dimensions 128 based on the analysis dimensions 108. Each of the dimensions 128 includes a plurality of dimensional subsets 130 including claims sharing common values for the dimension attributes associated with the particular dimension 128. For example, for dimension 128 having dimension attributes city and state, the dimension 128 may include a dimensional subset 130 including claims having a city and state of “Dallas, Tex.” In some implementations, the dimensions 128 and the dimensional subsets 130 may be stored in a memory of the analysis server 110 during processing. The dimensions 128 and the dimensional subsets 130 may also be stored in the database 102.

The dimensional analysis component 112 may produce dimensions 128 including different permutations of the dimension attributes defined by a particular analysis dimension 108. For example, a particular analysis dimension 108 may include the attributes healthcare provider, city, and state. The dimensional analysis component 112 may produce a dimension 128 defined by all the attributes included in the particular analysis dimension 108, and may produce additional dimensions 128 defined by healthcare provider only, city only, state only, healthcare provider and city, healthcare provider and state, and city and state.

As previously described, the dimensional analysis component 112 may produce subset metrics 132 associated with each of the dimensional subsets 130. The dimensional analysis component 112 may compare the subset metrics 132 to the baseline metrics 106 to determine if a particular dimensional subset 130 associated with the subset metrics 132 should be identified as an outlier subset 134. In some implementations, the dimensional analysis component 112 may identify a dimensional subset 130 as an outlier subset 134 if the difference between its associated subset metrics 132 and the baseline metrics 106 is greater than an outlier threshold. For example, the dimensional analysis component 112 may identify a dimensional subset 130 as an outlier subset 134 if the baseline metric 106 for overpaid claims is 10%, the subset metric 132 for overpaid claims is 20%, and the outlier threshold is 5%. In some cases, each type of metric may be associated with a different outlier threshold.

The analysis server 110 may provide the identified outlier subsets 134 to the client 120. In some implementations, the analysis server 110 provides the outlier subsets to the client 120 over a communications network. In some cases, the outlier subsets 134 are provided in response to a request received from the client 120. In addition to the outlier subsets 134, the analysis server 110 may provide information about the outlier subsets 134, including, but not limited to, the subset metrics 132 associated with each outlier subset 134, the differences between the subset metrics 132 and the baseline metrics 106, priority information associated with the outlier subsets 134, or other information.

In some cases, the client 120 may be computing device into vacation with the analysis server 110, including, but not limited to, a desktop computer, a laptop computer, a tablet, a mobile device such as a phone, or other types of computing devices. The client 120 may execute a client application 122. In some cases, the client application 122 may be operable to present the information received from the analysis server 110 to a user. The client application 122 may include a graphical user interface for presenting the information. In some cases, the client application 122 may communicate with the database 102, such as to perform additional queries to retrieve additional information about the outlier subsets 134 for presentation to the user. In some implementations, the client application 122 may be a web browser.

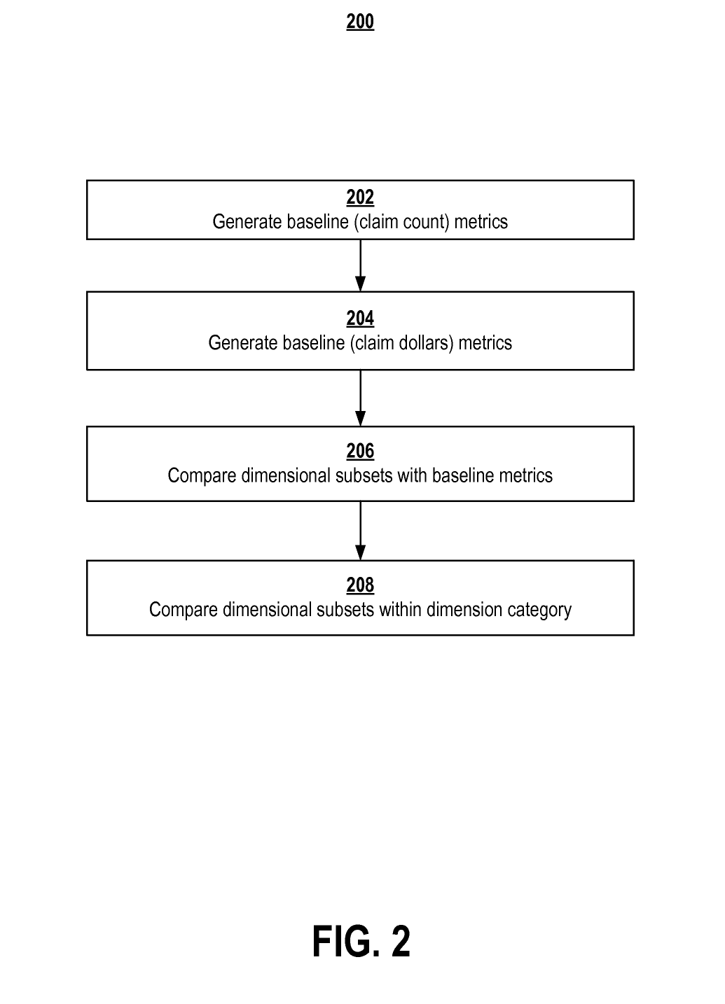

FIG. 2 is a flow chart of an example method 200 for performing dimensional analysis on a data set to identify subsets of records that deviate from baseline metrics. At 202, baseline claim count metrics are generated. As described above, the baseline claim count metrics be generated based on the claims 104. The baseline claim count metrics may include statistics related to the number of claims exhibiting a particular anomaly. For example, a baseline claim count metric may represent a percentage of the claims 104 that were overpaid. In some cases, the baseline claim count metrics may be expressed as a percentage or ratio of the total number of claims 104. The baseline claim count metrics may also include an aggregate number of claims exhibiting a particular anomaly.

At 204, baseline claim dollars metrics are generated. As described above, the baseline claim dollars metrics be generated based on the claims 104. The baseline claim dollars metrics may include statistics related to the monetary amounts associated with claims exhibiting a particular anomaly. For example, a baseline claim dollars metric may represent the average payment difference of the claims 104 that were overpaid. In some cases, the baseline claim count metrics may be expressed as an average (e.g., the average number of dollars difference between an expected and actual payment amount) or as an aggregate (e.g., the total number of dollars difference between the expected and actual payment amounts) of the claims 104.

At 206, dimensional subsets are compared with the baseline metrics. In some cases, this comparison may take place as described relative to FIG. 1. At 208, dimensional subsets within a dimension are compared. By comparing the dimensional subsets within a dimension to one another, the dimensional subsets that exhibit the greatest difference from the baseline metrics may be identified, and prioritized for further analysis. For example, a dimensional subset showing a 10% difference from a particular baseline metric may be prioritized over a dimensional subset showing a 5% difference from the particular baseline metric.

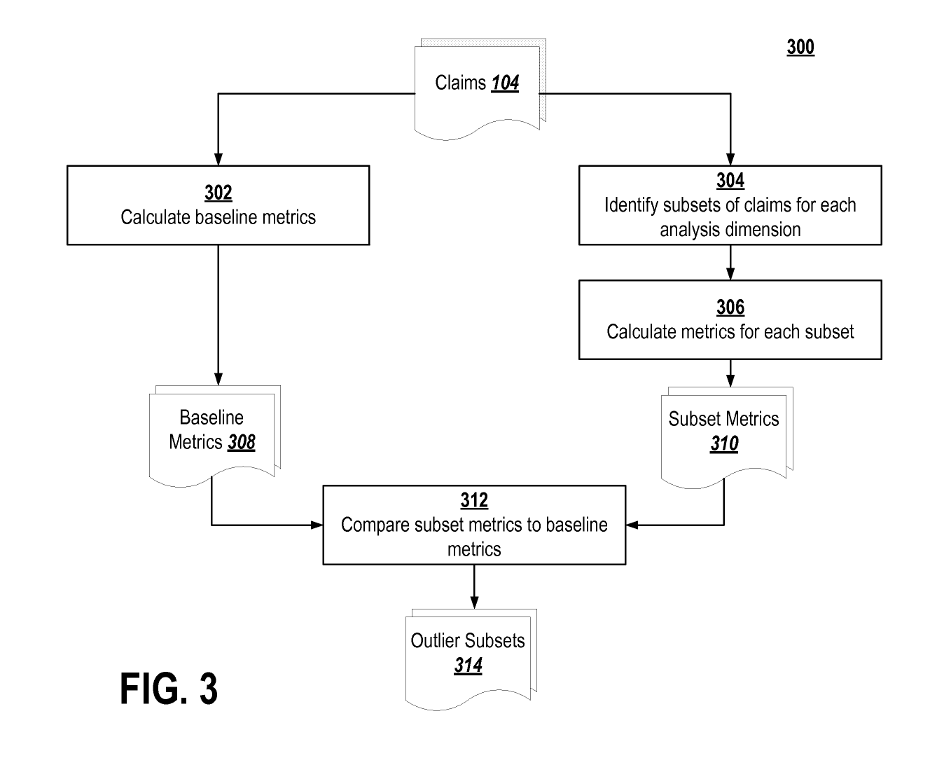

FIG. 3 is a flow chart of an example method 300 for generating baseline metrics and subset metrics, and comparing the two to identify outlier subsets. At 302, baseline metrics 308 are calculated based on the claims 104 as previously described relative to FIG. 1. At 304, subsets of claims for each analysis dimensional subsets for each analysis dimension are identified. At 306, subset metrics 310 for each dimensional subset are calculated. At 312, the subset metrics 310 for the dimensional subsets are compared to the baseline metrics 308 to identify outlier subsets 314 having subset metrics 310 that differ from the baseline metrics 308.

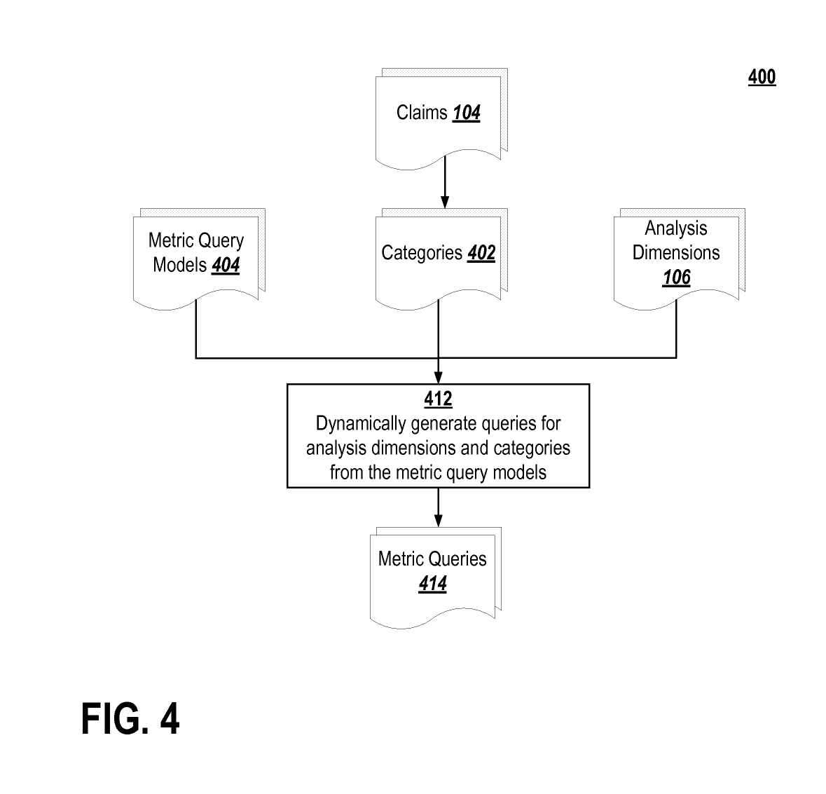

FIG. 4 is a flow chart of an example method 400 for generating metric queries. Categories 402 are subsets of the set of claims 104, such as, for example, a subset of claims for a certain date range, a subset of claims exhibiting overpayment, or other subsets. In some cases, the categories 402 identified by querying the database tables storing the claims 104 to produce the subsets associated with the categories 402.

Metric query models 404 are template queries from which the metric queries 414 are generated. For example, the metric query models 404 may be SQL statements to calculate particular metrics with placeholder values in a WHERE clause that are filled in to identify the subset of the claims 104 that a particular metric query 414 applies to. For example, a metric query model 404 may have the following where clause added when generating a metric query 414 to apply to a dimensional subset defined by a city of “Dallas” and the state of “Texas”: “WHERE city=‘Dallas’ AND state=‘Texas’”.

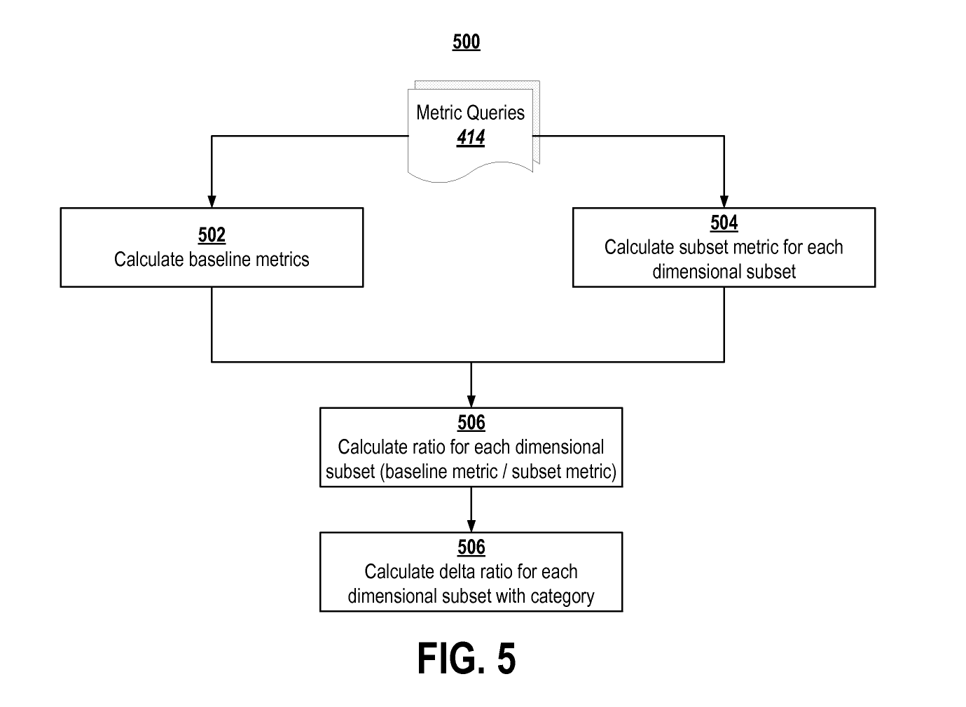

FIG. 5 is a flow chart of an example method 500 for comparing dimensions for a particular category (e.g., a subset of claims). At 502, baseline metrics are calculated by running the appropriate metric queries 414 associated with the baseline metrics. At 504, subset metrics are calculated for each dimensional subset within a dimension by running the appropriate metric queries 414 associated with each dimensional subset. As 506, ratios for each dimensional subset are calculated for each metric with the baseline metric as the numerator and the subset metric as the denominator. At 508, a delta ratio for the dimension is computed by comparing the ratio of the dimension with the baseline metric. In some cases, the delta ratio is computed by dividing the difference between the dimension ratio and the baseline ratio by the dimension ratio.

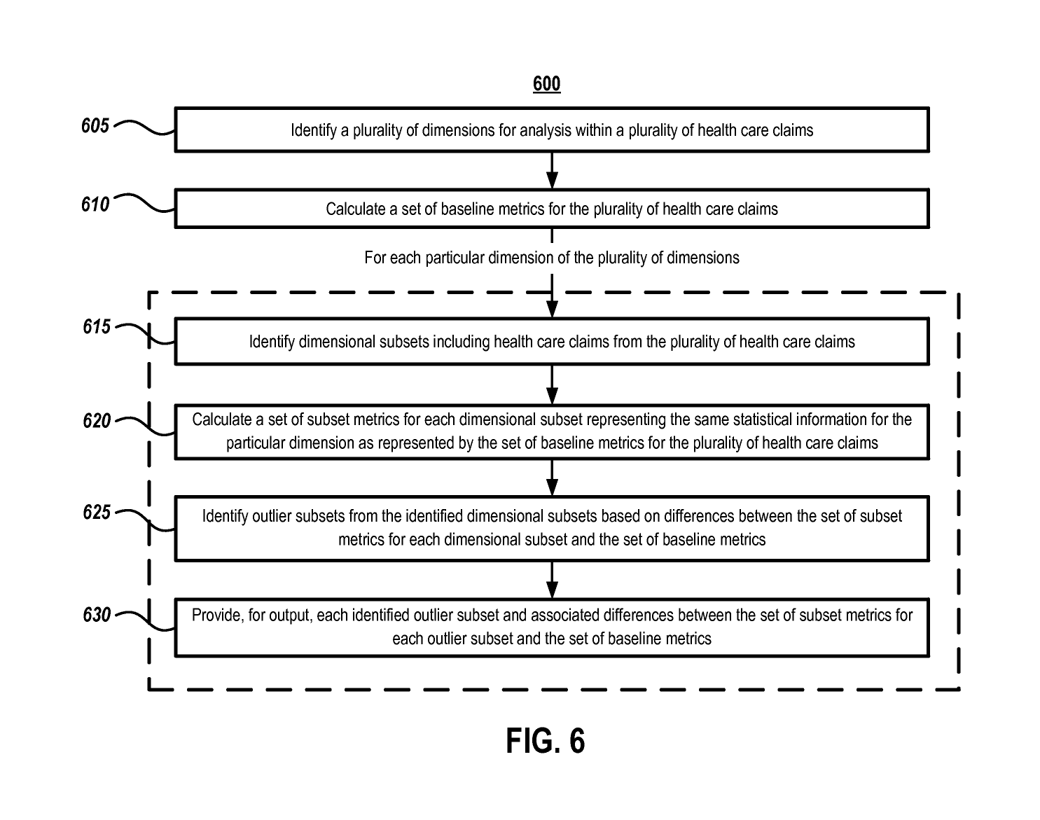

FIG. 6 is a flow chart of another example method 600 for performing dimensional analysis on a data set to identify subsets of records that deviate from baseline metrics. At 605, a plurality of dimensions for analysis are identified within a plurality of healthcare claims, each dimension defined by one or more dimension attributes included in each healthcare claim.

At 610, a set of baseline metrics are calculated for the plurality of healthcare claims representing statistical information about the plurality of healthcare claims. In some cases, the set of baseline metrics includes percentage of overpaid claims, percentage of underpaid claims, percentage of correctly paid claims, percentage of claims having non-financial edits, or other metrics. In some implementations, the set of baselines includes an average monetary amount for each overpaid claim, or an average monetary amount for each underpaid claim.

The remaining actions are performed for each particular dimension of the plurality of dimensions. At 615, dimensional subsets are identified including healthcare claims from the plurality of healthcare claims including healthcare claims with matching values for each of the one or more dimension attributes defining the particular dimension.

At 620, a set of subset metrics are calculated for each dimensional subset. The subset metrics represent the same statistical information for the particular dimension as represented by the set of baseline metrics.

At 625, outlier subsets are identified from the identified dimensional subsets based on differences between the set of subset metrics for each dimensional subset and the set of baseline metrics. In some cases, identifying outlier subsets includes determining that at least one metric from the set of subset metrics for a particular dimensional subset is different from a corresponding baseline metric by at least a threshold amount, and identifying the particular dimensional subset as an outlier subset based on the determination.

At 630, each identified outlier subset and associated differences between the set of subset metrics for each outlier subset and the set of baseline metrics are provided for output. In some cases, this includes generating a report to a user showing a prioritized list of identified dimensional subsets for further analysis, wherein the prioritized list is order based on an amount of different between the subset metrics for each dimensional subset and the baseline metrics; and generating a user interface configured to present the generated report and allowing the user to assign each of the identified dimensional subsets to an auditor for further analysis.

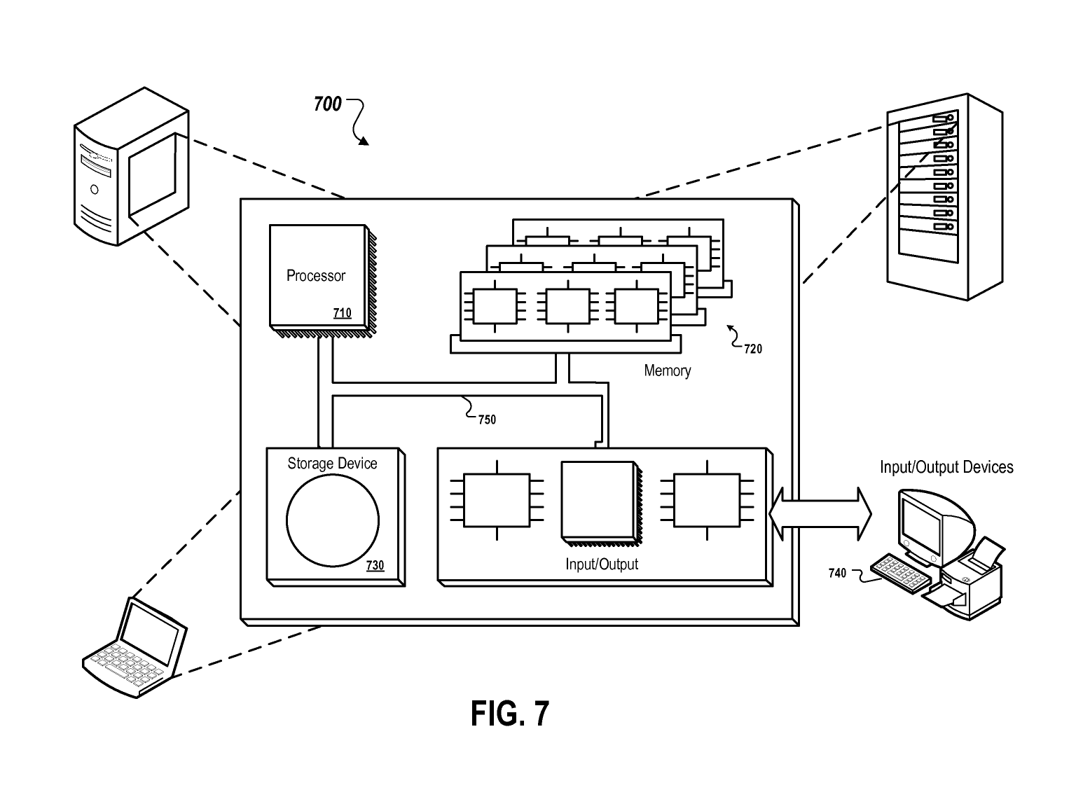

FIG. 7 is a schematic diagram of an example of a generic computer system. The system 700 can be used for the operations described in association with the methods 200-600. The system 700 may be included in the system 100.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit. The processor 710 and the memory 720 may perform data manipulation and validation, including execution of data quality jobs.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device. The storage device 730 may store monitoring data collected and data quality rule representations.

The input/output device 740 provides input/output operations for the system 700. In one implementation, the input/output device 740 includes a keyboard and/or pointing device. In another implementation, the input/output device 740 includes a display unit for displaying graphical user interfaces. The input/output device 740 may be used to perform data exchange with source and target data quality management and/or processing systems.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by one or more processors, the method comprising:
identifying a plurality of dimensions for analysis within a plurality of healthcare claims, each dimension defined by one or more dimension attributes included in each healthcare claim;
calculating a set of baseline metrics for the plurality of healthcare claims representing statistical information about the plurality of healthcare claims; and
for each particular dimension of the plurality of dimensions:
identifying dimensional subsets including healthcare claims from the plurality of healthcare claims, wherein each dimensional subset includes healthcare claims with matching values for each of the one or more dimension attributes defining the particular dimension;
calculating a set of subset metrics for each dimensional subset representing the same statistical information for the particular dimension as represented by the set of baseline metrics for the plurality of healthcare claims;
identifying outlier subsets from the identified dimensional subsets based on differences between the set of subset metrics for each dimensional subset and the set of baseline metrics; and
providing, for output, each identified outlier subset and associated differences between the set of subset metrics for each outlier subset and the set of baseline metrics.

2. The method of claim 1, wherein the set of baseline metrics includes at least one of: percentage of overpaid claims, percentage of underpaid claims, or percentage of correctly paid claims.

3. The method of claim 1, wherein the set of baseline metrics includes a percentage of claims on which a non-financial edit was performed.

4. The method of claim 1, wherein the set of baseline metrics includes at least one of: an average monetary amount for each overpaid claim, or an average monetary amount for each underpaid claim.

5. The method of claim 1, wherein the set of baseline metrics includes at least one of: an average monetary amount for each overpaid claim, or an average monetary amount for each underpaid claim.

6. The method of claim 1, wherein identifying outlier subsets includes determining that at least one metric from the set of subset metrics for a particular dimensional subset is different from a corresponding baseline metric by at least a threshold amount, and identifying the particular dimensional subset as an outlier subset based on the determination.

7. The method of claim 1, wherein providing, for output, each outlier subset and associated differences between the set of subset metrics for each outlier subset and the set of baseline metrics:
generating a report to a user showing a prioritized list of outlier subsets, wherein the prioritized list is order based on an amount of different between the subset metrics for each outlier subset and the baseline metrics; and
generating a user interface configured to present the generated report and allowing the user to assign each of the outlier subsets to an auditor for further analysis.

8. A non-transitory, computer-readable medium storing instructions operable when executed to cause at least one processor to perform operations comprising:
identifying a plurality of dimensions for analysis within a plurality of healthcare claims, each dimension defined by one or more dimension attributes included in each healthcare claim;
calculating a set of baseline metrics for the plurality of healthcare claims representing statistical information about the plurality of healthcare claims; and
for each particular dimension of the plurality of dimensions:
identifying dimensional subsets including healthcare claims from the plurality of healthcare claims, wherein each dimensional subset includes healthcare claims with matching values for each of the one or more dimension attributes defining the particular dimension;
calculating a set of subset metrics for each dimensional subset representing the same statistical information for the particular dimension as represented by the set of baseline metrics for the plurality of healthcare claims;
identifying outlier subsets from the identified dimensional subsets based on differences between the set of subset metrics for each dimensional subset and the set of baseline metrics; and
providing, for output, each identified outlier subset and associated differences between the set of subset metrics for each outlier subset and the set of baseline metrics.

9. The computer-readable medium of claim 8, wherein the set of baseline metrics includes at least one of: percentage of overpaid claims, percentage of underpaid claims, or percentage of correctly paid claims.

10. The computer-readable medium of claim 8, wherein the set of baseline metrics includes a percentage of claims on which a non-financial edit was performed.

11. The computer-readable medium of claim 8, wherein the set of baseline metrics includes at least one of: an average monetary amount for each overpaid claim, or an average monetary amount for each underpaid claim.

12. The computer-readable medium of claim 8, wherein the set of baseline metrics includes at least one of: an average monetary amount for each overpaid claim, or an average monetary amount for each underpaid claim.

13. The computer-readable medium of claim 8, wherein identifying outlier subsets includes determining that at least one metric from the set of subset metrics for a particular dimensional subset is different from a corresponding baseline metric by at least a threshold amount, and identifying the particular dimensional subset as an outlier subset based on the determination.

14. The computer-readable medium of claim 8, wherein providing, for output, each outlier subset and associated differences between the set of subset metrics for each outlier subset and the set of baseline metrics:
generating a report to a user showing a prioritized list of outlier subsets, wherein the prioritized list is order based on an amount of different between the subset metrics for each outlier subset and the baseline metrics; and
generating a user interface configured to present the generated report and allowing the user to assign each of the outlier subsets to an auditor for further analysis.

15. A system comprising:
memory for storing data; and
one or more processors operable to perform operations comprising:
identifying a plurality of dimensions for analysis within a plurality of healthcare claims, each dimension defined by one or more dimension attributes included in each healthcare claim;
calculating a set of baseline metrics for the plurality of healthcare claims representing statistical information about the plurality of healthcare claims; and
for each particular dimension of the plurality of dimensions:
identifying dimensional subsets including healthcare claims from the plurality of healthcare claims, wherein each dimensional subset includes healthcare claims with matching values for each of the one or more dimension attributes defining the particular dimension;
calculating a set of subset metrics for each dimensional subset representing the same statistical information for the particular dimension as represented by the set of baseline metrics for the plurality of healthcare claims;
identifying outlier subsets from the identified dimensional subsets based on differences between the set of subset metrics for each dimensional subset and the set of baseline metrics; and
providing, for output, each identified outlier subset and associated differences between the set of subset metrics for each outlier subset and the set of baseline metrics.

16. The system of claim 15, wherein the set of baseline metrics includes at least one of: percentage of overpaid claims, percentage of underpaid claims, or percentage of correctly paid claims.

17. The system of claim 15, wherein the set of baseline metrics includes a percentage of claims on which a non-financial edit was performed.

18. The system of claim 15, wherein the set of baseline metrics includes at least one of: an average monetary amount for each overpaid claim, or an average monetary amount for each underpaid claim.

19. The system of claim 15, wherein the set of baseline metrics includes at least one of: an average monetary amount for each overpaid claim, or an average monetary amount for each underpaid claim.

20. The system of claim 15, wherein identifying outlier subsets includes determining that at least one metric from the set of subset metrics for a particular dimensional subset is different from a corresponding baseline metric by at least a threshold amount, and identifying the particular dimensional subset as an outlier subset based on the determination.
